(19) United States
(12) Patent Application Publication
(10) Pub. No.: US 2008/0008952 A1
(43) Pub. Date: Jan. 10, 2008

(54) Organophotoreceptor and electrophotographic imaging apparatus including the organophotoreceptor

(75) Inventor: An-kee Lim, Gunpo-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/635,558

(22) Filed: Dec. 8, 2006

(30) Foreign Application Priority Data
Jul. 10, 2006 (KR) 10-2006-0064460

(51) Int. Cl. G03G 5/047; G03G 5/14

(52) U.S. Cl. 430/59.5; 430/59.4; 430/970; 430/59.6; 430/60

(57) ABSTRACT

An organophotoreceptor and an electrophotographic imaging apparatus including the organophotoreceptor are provided. The organophotoreceptor provides an excellent image quality by preventing an optical fatigue and a thermal fatigue occurring when repeatedly used. The organophotoreceptor includes a conductive support, an undercoat comprising a metal oxide and antioxidant dispersed in a binder, a charge generation layer comprising a phthalocyanine-based pigment, and a charge transport layer.

### CROSS-REFERENCE TO RELATED PATENT APPLICATION

This application claims the benefit of Korean Patent Application No. 10-2006-0064460, filed on Jul. 10, 2006, in the Korean Intellectual Property Office, the disclosure of which is hereby incorporated by reference in its entirety.

### BACKGROUND OF THE INVENTION

1. Field of the Invention

The present invention relates to an organophotoreceptor and to an electrophotographic imaging apparatus including the organophotoreceptor. More particularly, the invention relates to an organophotoreceptor that provides excellent image quality by preventing optical fatigue and thermal fatigue that normally occurs when the organophotoreceptor is repeatedly used and an electrophotographic imaging apparatus including the same.

2. Description of the Related Art

In general, an electrophotographic photoreceptor includes an alumite layer, a charge generation layer, and a charge transport layer, which are sequentially deposited on an aluminum drum. However, more typically an electrophotographic photoreceptor includes an undercoat, a charge generation layer, and a charge transport layer sequentially deposited on an aluminum drum. The alumite layer is expensive to manufacture, and the undercoat is unstable in an apparatus that includes an electrophotographic photoreceptor. Organic photoconductive materials such as a naphthoquinone-based compound, an azo-based compound, an azulenium salt-based compound, a pyrylium salt-based compound, a phthalocyanine-based compound, and the like are sensitive to semiconductor laser light. However, a naphthoquinone-based compound has low sensitivity, and an azo-based compound cannot be stably synthesized. In particular, a naphthoquinone-based compound and an azo-based compound are chemically unstable with respect to strong light, such as laser light.

On the other hand, phthalocyanine-based compound are chemically and physically stable and thus is used as a blue pigment in a wide range of applications, such as inks and paints, and charge generating materials for electrophotographic photoreceptors.

In general, phthalocyanine-based compounds have different ultraviolet light and visible light absorption spectra and electrical properties according to the kind of a central metal in their molecular structure, and thus have different properties as a charge generation material for an electrophotographic photoreceptor. In addition, even when their central metals are the same, their properties can vary according to crystalline structure or particle size.

There are many phthalocyanine-based charge generating materials, such as copper phthalocyanine, nonmetallic phthalocyanine, chloro aluminum phthalocyanine, chloro indium phthalocyanine, chloro galium phthalocyanine, chloro germanium phthalocyanine, oxobanadyl phthalocyanine, oxotitanyl phthalocyanine, hydroxy germanium phthalocyanine, hydroxy gallium phthalocyanine and the like.

In addition, electrophotographic photoreceptors can be prepared by coating a composition including a photoconductive pigment dispersed in a binder resin on a conductive support, by sequentially depositing a charge generation layer and a charge transport layer on a conductive support, by sequentially depositing a charge transport layer and a charge generation layer on a conductive support, or by coating a charge generating material dispersed-composition in a charge transport layer on a conductive support. Electrophotographic photoreceptors having these structures are susceptible to optical fatigue, have low durability due to heat generated during repeated use of a device, such as a printer, and have image aging characteristics due to changes in temperature and humidity. When a photoreceptor drum that experiences optical fatigue and deteriorated output, the resulting image obtained during the development process may have low concentration or defects. These problems can be solved by using an antioxidant or an ultraviolet light absorbing agent. However, there is still a need to develop a proper technique to prevent these problems. In addition, when an undercoat is prepared by coating a composition including a metal oxide dispersed in a binder resin on a conductive support, image aging occurs since the binder resin and the metal oxide are very susceptible to changes in the environment.

A phthalocyanine-based charge generating material used as a charge generating material is manufactured in an aggregated crystal state of primary particles and has a particle size of a few microns or more. Accordingly, when the phthalocyanine-based charge generating material is used to prepare an electrophotographic photoreceptor, the phthalocyanine-based charge generating material of an aggregated crystal state is first dispersed using a proper organic solvent to prepare a dispersion coating solution so that particulates of the phthalocyanine-based charge generating material can be obtained. The dispersion coating solution is coated on a conductive substrate to form a thin film. At this point, when the charge generating material included in the dispersion coating solution undergoes crystal transition or crystal growth, or aggregates to thereby form large particles, electrophotographic characteristics may deteriorate or the obtained thin film may have irregular electrical characteristics. In addition, image defects, such as black spots may occur and image resolution may decrease. Due to these problems, the charge generating material in the dispersing solution having stability with respect to crystal transition, crystal growth or aggregation is required. It is known that the phthalocyanine-based compound has various crystal forms and these crystal forms are thermodynamically stable when synthesized. However, when the phthalocyanine-based compound undergoes a crystal form transition process to be used for electrophotographic use, the phthalocyanine-based compound changes into an unstable crystal form or a semi-stable crystal form. In particular, in an organic solvent, the phthalocyanine-based compound is unstable with respect to crystal transition or crystal growth and aggregation.

However, there are no phthalocyanine-based charge generating materials that can overcome these problems as described above. An oxotitanyl phthalocyanine of a Y-type crystal form has the sharpest diffraction peak at a Bragg angle 2θ(±0.2°) of 27.3° in an X-ray diffraction spectrum and relatively good sensitivity. Various other crystal forms having different properties have been suggested. However, this crystal form belongs to a type II crystal form having poor resistance to solvents. That is, the oxotitanyl phthalocyanine of a Y-type crystal form itself has relatively high sensitivity, but is unstable with respect to solvents (refer to Japanese Patent Laid-open Publication No. Sho 62-67094).

Since the crystal characteristics age in dispersion coating solutions of a conventional phthalocyanine-based charge generating material, the photoreceptor has poor properties such as poor stability, bad credibility. In addition, the photoreceptor has low storage stability and thus increased manufacturing costs.

A conventional phthalocyanine-based charge generating material has excellent sensitivity when its dispersion coating solution is prepared. However, crystal properties of the phthalocyanine-based charge generating material in the coating solution substantially age and the phthalocyanine-based charge generating material is very unstable. Therefore, there are many problems in terms of quality stabilization, manufacturing properties, and photoreceptor costs.

Accordingly, there is a need to develop a suppressant that prevents a change in crystal form of the phthalocyanine-based charge generating material while electrophotographic properties are maintained There is also a need for a dispersion stabilizer that prevents aggregation of crystals, a charge generating material having high sensitivity that is stable with respect to crystal growth or crystal aggregation, and a photoreceptor that is suitable for processing digital signals.

### SUMMARY OF THE INVENTION

The present invention provides an organophotoreceptor having improved aging characteristics due to an optical fatigue and thermal fatigue occurring repeated used.

The present invention also provides an electrophotographic imaging apparatus including the organophotoreceptor, an electrophotographic cartridge including the organophotoreceptor, and an electrophotographic drum including the organophotoreceptor.

According to an aspect of the present invention, an organophotoreceptor is provided that includes a conductive support; an undercoat comprising a metal oxide and antioxidant dispersed in a binder; a charge generation layer comprising a phthalocyanine-based pigment; and a charge transport layer.

The antioxidant may be a phenol-based antioxidant, a phosphite-based antioxidant, or a mixture thereof.

The phthalocyanine-based pigment may be a phthalocyanine-based derivative of Formula 1, a phthalocyanine-based compound of Formula 2, or a mixture or cocrystal thereof:

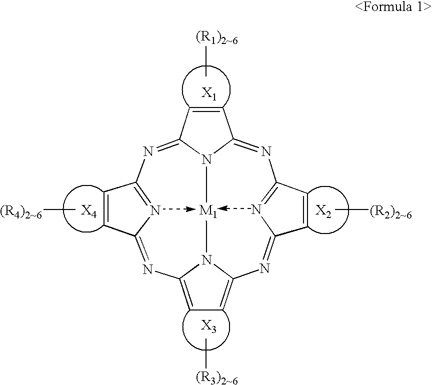

where X₁, X₂, X₃, and X₄ are each independently a substituted or unsubstituted 2,3-naphthalene ring or a substituted or unsubstituted benzene ring, and at least one of X₁, X₂, X₃, and X₄ is a 2,3-naphthalene ring;

R₁, R₂, R₃, and R₄ are each independently a hydrogen atom, a halogen atom, a nitro group, a substituted or unsubstituted C₁₋₂₀ alkyl group, or a substituted or unsubstituted C₁₋₂₀ alkoxy group; and

M₁ is a hydrogen molecule, a halogenated aluminum, or Ti, V, Zr, Ge, Ga, Sn, Si, or In to which an oxygen atom, a halogen atom, or hydroxyl group is bound;

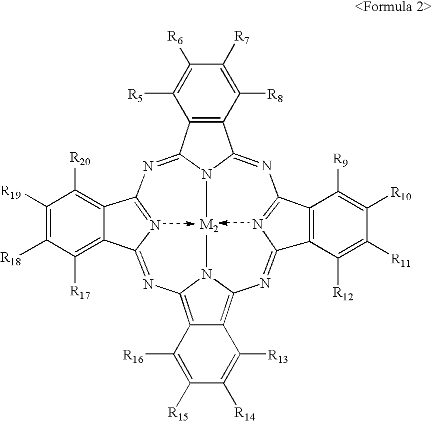

where M₂ is a hydrogen molecule, Cu, Fe, Mg, Sn, Pb, Zn, Co, Ni, Mo, halogenated aluminum, or Ti, V, Zr, Ge, Ga, Sn, Si, or In to which an oxygen atom, a halogen atom, or a hydroxyl group is bound; and

R₅, R₆, R₇, R₈, R₉, R₁₀, R₁₁, R₁₂, R₁₃, R₁₄, R₁₅, R₁₆, R₁₇, R₁₈, R₁₉, and R₂₀ are each independently a hydrogen atom, a halogen atom, a nitro group, a substituted or unsubstituted C₁₋₂₀ alkyl group, or a substituted or unsubstituted C₁₋₂₀ alkoxy group.

According to another aspect of the present invention, an electrophotographic imaging apparatus is provided that includes the organophotoreceptor.

According to another aspect of the present invention, an electrophotographic cartridge is provided that is installed in an electrophotographic imaging apparatus and is seperated from the electrophotographic imaging apparatus, the electrophotographic cartridge including: an organophotoreceptor including a conductive support, an undercoat comprising a metal oxide and antioxidant dispersed in a binder, a charge generation layer comprising a phthalocyanine-based pigment, and a charge transport layer that includes a charge transport material; and at least one device selected from the group consisting of a charging device that charges the organophotoreceptor, a developing device that develops a electrostatic latent image formed on the organophotoreceptor, and a cleaning device that cleans the surface of the organophotoreceptor.

According to another aspect of the present invention, an electrophotographic drum is provided that includes: a drum that is installed in an electrophotographic imaging apparatus and is separated from the electrophotographic imaging apparatus imaging apparatus; and an organophotoreceptor including a conductive support; an undercoat comprising a metal oxide and antioxidant dispersed in a binder; a charge generation layer comprising a phthalocyanine-based pigment; and a charge transport layer including a charge transporting material and a second antioxidant dispersed in a second binder.

According to another aspect of the present invention, an electrophotographic imaging apparatus is provided that includes: a photoreceptor unit including a conductive support; an undercoat comprising a metal oxide and antioxidant dispersed in a binder; a charge generation layer comprising a phthalocyanine-based pigment; and a charge transport layer including a charge transporting material; a charging device that charges the photoreceptor unit; an imagewise light irradiation device that irradiates an imagewise light to a photoreceptor unit charged by the charging device in order to form a electrostatic latent image on the photoreceptor unit; a developing unit that develops the elastic latent image using a toner in order to form a toner image on the photoreceptor unit; and a transferring device that transfers the toner image onto a receptor.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view of an electrophotographic imaging apparatus including an electrophotographic drum and an electrophotographic cartridge, according to an embodiment of the present invention;

FIG. 2 is an XRD chart of a pigment that has undergone a crystal form transition treatment according to Preparation Example 2;

FIG. 3 is an XRD chart of a pigment that has undergone a crystal form transition treatment according to Preparation Example 3; and

FIG. 4 is an XRD chart of a pigment that has undergone a crystal form transition treatment according to Preparation Example 4.

### DETAILED DESCRIPTION OF THE INVENTION

The present invention will now be described more fully with reference to the accompanying drawings.

In an electrophotographic organophotoreceptor according to an embodiment of the present invention, an antioxidant having a specific structure is used in an undercoat and a charge transport layer and a phthalocyanine-based pigment is used in a charge generation layer. The electrophotographic organophotoreceptor having such features undergoes less optical fatigue and thermal fatigue due to environmental changes occurring during repeated use. In addition, when an electrophotographic device, such as a laser printer, a digital copier, or a facsimile, includes the electrophotographic organophotoreceptor, image aging characteristics occurring when used for a long period of time can improve even when an external environment is dramatically changed and its durability improves, and thus excellent image properties can be obtained.

According to the present invention, a metal oxide used in an undercoat, a charge generating material, and a charge transporting material are appropriately combined so that electrophotographic properties of an organophotoreceptor improves, image defects can be prevented, print products having high resolution can be obtained. The electrophotographic organophotoreceptor in which the metal oxide of the undercoat, the charge generating material, and the charge transporting material are appropriately combined has high sensitiveness, excellent charge potential retention properties, low aging properties, high heat resistance, high durability, and excellent image properties, and thus has high credibility.

The organophotoreceptor according to an embodiment of the present invention is obtained by forming an undercoat, a charge generation layer, and a charge transport layer on a conductive support. The conductive support can be formed of a metallic substance, such as aluminum, aluminum alloy, stainless copper, copper, or nickel. Alternatively, the conductive support can be an insulating substrate coated with a conductive film of aluminum, copper, palladium, tin oxide, or indium oxide. The insulating substrate can be formed of polyester film, paper, glass and the like. Meanwhile, a positive electrode oxide film can be formed using a sulfuric acid solution, oxalic acid, and others between the conductive support and the charge generation layer, or a binder layer formed of a polyamide resin, a polyurethane resin, or an epoxy resin can be coated between the conductive support and the charge generation layer.

The undercoat formed on the conductive support used in the embodiment of the present invention includes a metal oxide and antioxidant dispersed in a binder. The amount of the antioxidant may be in the range of about 0.01-20 parts by weight based on 100 parts by weight of the binder. When the amount of the antioxidant is less than 0.01 parts by weight, the occurrence of the image aging is less suppressed. On the other hand, when the amount of the antioxidant is more than 20 parts by weight, an image may be blurred.

The antioxidant can be a phenol-based antioxidant, phosphite-based antioxidant, or a mixture of these. The phenol-based antioxidant can be 2,6-di-tert-butylphenol, 2,6-di-tert-butyl-4-methoxyphenol, 2,6-di-tert-butyl-4-methylphenol, 2-tert-butyl-4-methoxyphenol, 2,4-dimethyl-6-tert-butylphenol, 2-tert-butylphenol, 3,6-di-tert-butylphenol, 2,4-di-tert-butylphenol, 2,6-di-tert-butyl-4-ethylphenol, 2-tert-butyl-4,6-methylphenol, 2,4,6-tert-butylphenol, 2,6-di-tert-butyl-4-stearylpronate phenol, α-tocopherol, β-tocopherol, γ-tocopherol, naphthol AS, naphthol AS-D, naphthol AS-BO, 4,4′-methylenebis(2,6-di-tert-butylphenol), 4,4′-methylenebis(6-tert-butyl-4-methylphenol), 2,2′-methylenebis(4-methyl-6-tert-butylphenol), 2,2′-methylenebis(4-ethyl-6-tert-butylphenol), 2,2′-ethylenebis(4,6-di-tert-butylphenol), 2,2′-propylenebis(4,6-di-tert-butylphenol), 2,2′-butanebis(4,6-di-tert-butylphenol), 2,2′-ethylenebis(6-tert-butyl-m-crezole), 4,4′-butanebis(6-tert-butyl-m-crezole), 2,2′-butanebis((6-tert-butyl-p-crezole), 2,2′-thiobis((6-tert-butylphenol), 4,4′-thiobis(6-tert-butyl-m-crezole), 4,4′-thiobis(6-tert-o-crezole), 2,2′-thiobis(4-methyl-6-tert-butylphenol), 1,3,5-trimethyl-2,4,6-tris(3,5-di-tert-butyl-4-hydroxybenzyl)benzene, 1,3,5-trimethyl-2,4,6-tris(3,5-di-tert-amyl-4-hydroxybenzyl)benzene, 1,3,5-trimethyl-2,4,6-tris(3-tert-butyl-5-methyl-4-hydroxybenzyl)benzene, 2-tert-butyl-5-methyl-phenylaminephenol, 4,4′bisamino(2-tert-butyl-4-methylphenol), N-octadecyl-3-(3′,5 ′-di-tert-butyl-4′-hydroxyphenyl)propionate, 2,2,4-trimethyl-6-hydroxy-7-tert-butylchroman, tetrakis(methylene-3(3,5-di-tert-butyl-4-hydroxyphenyl)propionate)methane, 1,1,3-tris(2-methyl-4-hydroxy-5-tert-butylphenyl)butane, or a combination of these. However, the phenol-based antioxidant is not limited thereto.

The phosphite-based antioxidant can be tri(2,4-di-t-butylphenyl)phosphite, bis(2,4-di-t-butylphenyl)pentaerythritol diphosphite, bis(2,4-di-dicumylphenyl)pentaerythritol diphosphite, tri(4-n-nonylphenyl)phosphite, or tetrakis(2,4-di-tert-butyl-phenyl) 4,4′-biphenylene-diphosphite, or a combination of these, but is not limited thereto.

The metal oxide included in the undercoat may include at least one oxide selected from the group consisting of tin oxide, indium oxide, zinc oxide, titan oxide, silicon oxide, zirconium oxide, and aluminum oxide. In the present embodiment of the present invention, the metal oxide can be a rutile-type titan oxide, and by using about 0.01%-5% by weight of aluminum oxide titan oxide based on the weight (100%) of titan oxide, electrostatic properties can be improved and a printed smooth image can be obtained.

The binder included in the undercoat may include at least one resin selected from a thermosetting resin obtained by thermally polymerizing a oil-free alkyd resin, an amino resin, such as a butylated melamine resin, a photosetting resin obtained by polymerizing a polyurethane having an unsaturated bond or a resin having an unsaturated bond, such as unsaturated polyester, a polyamide resin, a polyurethane resin, an epoxy resin, or the like.

In the organophotoreceptor, the thickness of the undercoat may be in the range of about 0.1-20 μm, and preferably about 0.2-10 μm. When the thickness of the undercoat is less than 0.1 μm, pores can be formed in the undercoat due to a high charge voltage and black spots can be formed. On the other hand, when the thickness of the undercoat is more than 20 μm, it is difficult to control electrostatic properties and an image quality may decrease. In the undercoat, the weight ratio of the metal oxide and the binder may be in the range of about 0.1:1-10:1. When the relative amount of the binder is too high, the shielding effectiveness of the metal oxide may decrease. On the other hand, when the relative amount of the metal oxide is too high, the organophotoreceptor is less adhesive to a photoreceptor drum.

In the organophotoreceptor, the charge generation layer can be formed on the conductive support using a known method. A charge generating material used to form the charge generation layer can be an organic pigment, such as phthalocyanine-based pigment, perylene-based pigment, indigo-based pigment, quinacridon-based pigment, azo-based pigment, and preferably the phthalocyanine-based pigment.

The charge generating material can be deposited or sputtered to form a uniform layer. Alternatively, the pigment particles can be dispersed in a binder, such as polyester resin, phenoxy resin, or polyvinylbutyral resin, and then used to form a charge generation layer having a thickness of about 0.1-2 μm.

In the embodiment of the present invention, the phthalocyanine-based pigment is used as the charge generating material. The phthalocyanine-based pigment can be a phthalocyanine-based derivative of Formula 1, a phthalocyanine-based compound of Formula 2, or a mixture or cocrystal thereof:

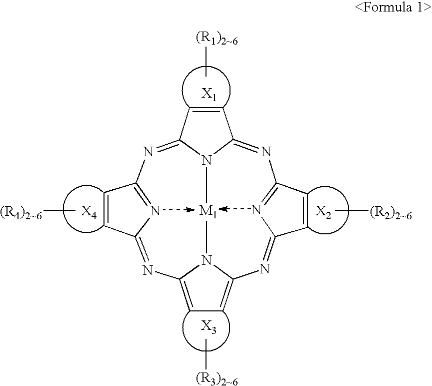

where X₁, X₂, X₃, and X₄ are each independently a substituted or unsubstituted 2,3-naphthalene ring or a substituted or unsubstituted benzene ring, and at least one of X₁, X₂, X₃, and X₄ is a 2,3-naphthalene ring;

R₁, R₂, R₃, and R₄ are each independently a hydrogen atom, a halogen atom, a nitro group, a substituted or unsubstituted C1-20 alkyl group, or a substituted or unsubstituted C1-C20 alkoxy group; and

M₁ is a hydrogen molecule, a halogenated aluminum, or Ti, V, Zr, Ge, Ga, Sn, Si, or In to which an oxygen atom, a halogen atom, or hydroxyl group is bound; and

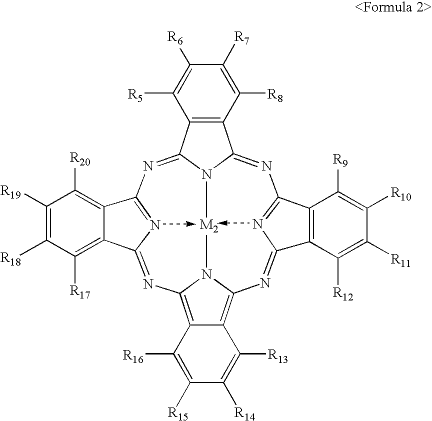

where M₂ is a hydrogen molecule, Cu, Fe, Mg, Sn, Pb, Zn, Co, Ni, Mo, halogenized aluminum, or Ti, V, Zr, Ge, Ga, Sn, Si, or In to which an oxygen atom, a halogen atom, or a hydroxyl group is bound; and

R₅, R₆, R₇, R₈, R₉, R₁₀, R₁₁, R₁₂, R₁₃, R₁₄, R₁₅, R₁₆, R₁₇, R₁₈, R₁₉, and R₂₀ are each independently a hydrogen atom, a halogen atom, a nitro group, a substituted or unsubstituted C1-20 alkyl group, or a substituted or unsubstituted C1-20 alkoxy group.

The phthalocyanine compound used in the embodiment of the present invention can be easily synthesized using a known method (refer to F. H. Moser, A. L. Thomas “phthalocyanine compounds”, 1963; PB85172.FIAT.FINAL REPORT 1313.Feb. 1, 1948; Japanese Patent Laid-open Publication No. Hei 1-142658; and Japanese Patent Laid-open Publication No. Hei 1-221461) which are hereby incorporated by reference in their entirety.

When the phthalocyanine derivative of Formula 1 and the phthalocyanine compound of Formula 2 are used to prepare the phthalocyanine-based pigment used in the embodiment of the present invention have the same central atoms, that is, Ml of Formula 1 is identical to M₂ of Formula 2, the phthalocyanine derivative of Formula 1 and the phthalocyanine compound of Formula 2 can be prepared at the same time.

As more benzene rings of the phthalocyanine structure of the phthalocyanine derivative of Formula 1 are substituted, molecular planes of the phthalocyanine derivative of Formula 1 and the phthalocyanine compound of Formula 2 in the phthalocyanine-based cocrystal are deposited in a more irregular direction. Therefore, in order to obtain a cocrystal having a crystal form of high sensitiveness, the number of a benzene ring substituted with a 2,3-naphthalene ring that is substituted or unsubstituted with a halogen atom, a nitro group, an alkyl group, or alkoxy group of the phthalocyanine structure of the phthalocyanine derivative of Formula 1 may be three or less.

A method of preparing the phthalocyanine derivative of Formula 1 will now be described in detail. First, a desired substitute-containing dicarbonitril compound, such as 2,3-naphthalenedicarbonitril or 1,2-naphthalenedicarbonitril, is transformed into a corresponding imine salt by using a metal alkoxide so that the desired substitute-containing dicarbonitrile compound can have higher reactivity than phthalonitrile. Then, the corresponding imine salt is reacted with phthalonitrile, which is used to synthesize a phthalocyanine compound, to selectively synthesize a phthalocyanine derivative. Alternatively, 2,3-naphthalenedicarbonitril or 1,2-naphthalenedicarbonitril can be reacted with phthalonitrile to synthesize a phthalocyanine derivatives.

The first product obtained according to the method described above can be a mixture of a phthalocyanine compound and a phthalocyanine derivative in which benzene rings are substituted with desired substitutes in a ratio of 1:99-99:1. The mixture ratio may vary according to reaction conditions, such as a reaction temperature, a mole ratio of reactants, a method of adding reactants, or the like. The phthalocyanine derivative can be a phthalocyanine derivative substituted with one, two, or three substituents.

When the phthalocyanine-based pigment used in the embodiment of the present invention is the phthalocyanine derivative of Formula 1, it is not necessary to use a single kind of a phthalocyanine derivative. That is, the phthalocyanine-based pigment can be a mixture of at least two kinds of phthalocyanine derivatives having different substitutes and/or different central atoms.

An organic solvent used to synthesize the phthalocyanine derivative of Formula 1 obtained as described above or the phthalocyanine compound of Formula 2 may be an inert solvent having a high boiling point, such as α-chloronaphthalene, β-chloronaphthalene, α-methyl naphthalene, methoxy naphthalene, diphenyl naphthalene, ethylene glycol dialkyl ether, quinoline, sulforane, dichlorobenzene, N-methyl-2-pyrrolidone, or dichlorotoluene.

The phthalocyanine derivative of Formula 1 obtained as described above or the phthalocyanine compound of Formula 2 may be refined to increase its purity suitable for an electrophotographic use. The refining method can be a cleaning method, a recrystalizing method, an extraction method, a thermal suspension method, or a sublimation method, using an acid, alkali, acetone, methyl alcohol, ethyl alcohol, methyl ethyl ketone, tetrahydrofurane, pyridine, quinoline, sulforane, α-chloronaphthalene, toluene, xylene, dioxane, chloroform, dichloroethane, N,N-dimethylformamide, N-methyl-2-pyrrolidone, or water. In addition to these refining methods, other methods can be used to remove non-reacted products or side reaction products within the scope of the present invention.

When the phthalocyanine-based pigment is a mixture or a cocrystal of the phthalocyanine derivative of Formula 1 and the phthalocyanine compound of Formula 2, the weight ratio of the phthalocyanine derivative of Formula 1 and the phthalocyanine compound of Formula 2 may be about 1:1 or less, preferably about 0.0001:1-0.5:1, and more preferably about 0.0001:1-0.2:1, based on the weight of the phthalocyanine compound of Formula 2.

In the present specification, a cocrystal refers to a state in which at least two kinds of compounds are inserted in a molecular state in a primary crystal particle. Whether crystalline compounds are mixed in a form of a simple mixture or a cocrystal can be easily identified using a known analysis method based on the difference in properties. For example, such identification can be obtained using new diffraction angles or new absorption peaks appearing in an X-ray diffraction diagram, a ultraviolet light absorption spectrum, or a visible light absorption spectrum which are absent in the X-ray diffraction diagram, a ultraviolet light absorption spectrum, or a visible light absorption spectrum of initial (crude) compounds. Even when a simple mixture and a cocrystal have the same diffraction angles and absorption peaks in the same area, such identification can also be made. That is, even in this case, since the cocrystal and the simple mixture have different crystal forms or different growth rates, respective initial (crude) compounds are treated in the same manner as the process of preparing a cocrystal to produce a simple mixture which has the same composition as the cocrystal, and then the identification can be made from the difference in the diffraction intensity or absorption intensity or the difference in respective intensity ratios.

The cocrystal of the phthalocyanine derivative of Formula 1 and the phthalocyanine compound of Formula 2 is prepared by mixing the phthalocyanine derivative of Formula 1 and the phthalocyanine compound of Formula 2 in a molecular state according to a known method. That is, the phthalocyanine derivative of Formula 1 and the phthalocyanine compound of Formula 2 are dissolved into a molecular state in a strong acid, such as a sulfuric acid. Then, the resultant solution is added to a solvent, such as water or alcohol, and then treated using a chemical method, such as an acid pasting method that is used to precipitate cocrystal, or an acid slurry method. Alternatively, by using a mechanical method using a grinding or milling apparatus, the phthalocyanine derivative of Formula 1 and the phthalocyanine compound of Formula 2 can be treated together and physically combined into the same crystal. In this mechanical method, the phthalocyanine derivative of Formula 1 and the phthalocyanine compound of Formula 2 may be completely ground or milled until they become amorphous and then mixed.

It is important to uniformly mix the phthalocyanine derivative of Formula 1 and phthalocyanine compound of Formula 2 to make the phthalocyanine derivative of Formula 1 to effectively function with the phthalocyanine compound of Formula 2. Such a uniform composition can be obtained by using an additive used in the dispersion process. The cocrystal prepared as described above can be used as the charge generating material. However, when a specific crystal form is desired, the obtained composition can be post treated using a known method. In this case, a conversion efficiency can be increased by performing the post treatment in phthalocyanine compound crystal conversion conditions which are used when a phthalocyanine derivative is not present or by adding as a seed a compound having a crystal form desired as a crystal conversion derivative.

When the phthalocyanine derivative of Formula 1 and the phthalocyanine compound of Formula 2 which form the crystal mixture are oxotitanyl phthalocyanines, the cocrystal may have the sharpest diffraction peak at a Bragg angle (2θ+0.2°) of 27.1° in the X-ray diffraction spectrum, which is a crystal form of γ-type or Y-type oxotitanyl phthalocyanine, or have the sharpest diffraction peak at a Bragg angle (2θ±0.2°) of 7.5°, which is a crystal form of an α-type oxotitanyl phthalocyanine.

On the other hand, when the phthalocyanine derivative of Formula 1 and the phthalocyanine compound of Formula 2 which form the crystal mixture are nonmetallic phthalocyanines, the cocrystal may have sharp diffraction peaks at Bragg angles (2θ±0.2°) of 7.5° and 9.2°, which is a crystal form of an X-type nonmetallic phthalocyanine.

The grinding or milling apparatus used in the selective post treatment process to prepare a crystal mixture or obtain a crystal form conversion, can be an attritor, a ball-mill, a sand-mill, a high-speed mixer, a Branbury mixer, sback mixer, a roll-mill, a 3-roll mill, a nano mizer, a microfludizer, a stamp mill, a planetary mill, vibration mill, a kneader and the like. When required, a dispersion medium, such as a glass bead, a steel bead, a zirconium oxide bead, an aluminum oxide ball, a zirconium oxide ball, or flint can be used, during the milling. When required, a grinding agent, such as a table salt, sodium carbonate, or sodium sulfate, can be used during the grinding.

The organophotoreceptor according to an embodiment of the present invention may have a multi-layered structure in which the undercoat is deposited on the conductive support, and the charge generation layer and the charge transport layer are sequentially deposited to effectively generate and transport charge, or a single-layered structure in which a charge generation and transport layer is formed so that charges can be generated and transported in the same layer.

In the multi-layer photoreceptor, the charge generation layer is formed of the phthalocyanine-based pigment. The phthalocyanine-based pigment, however, cannot form a film when used alone. Accordingly, the phthalocyanine-based pigment is first dispersed with an appropriate binder and a solvent using a dispersing apparatus, and then the dispersion solution is coated on the conductive substrate and dried to form the charge generation layer. The amount of the phthalocyanine-based pigment contained in the charge generation layer maybe in the range of about 10-100 wt %, and preferably about 30-80 wt % based on the total weight of the generation layer. The thickness of the charge generation layer may be in the range of about 0.001-10 μm, and preferably about 0.05-2 μm. When thickness of the charge generation layer is less than 0.001 μm, it is difficult to obtain an uniform charge generation layer and an image quality may deteriorate. On the other hand, when the thickness of the charge generation layer is more than 10 μm, electrophotographic properties may decrease.

The charge transport layer is formed on the charge generation layer. A charge transporting material can be both a hole transporting material that transports holes and an electron transporting material that transports electrons. When the multi-layer photoreceptor is a negatively charged type, the charge transporting material is the hole transporting material. When the multi-layer photoreceptor is a positively charged type, the charge transporting material primarily consists of the electron transporting material. When the multi-layer photoreceptor has positive and negative polarities, the hole transporting material and the transporting material are used together for use. When the charge transporting material has a film forming capability, the charge transporting material itself can be used to form the charge transport layer. However, in general, the charge transporting material in a low molecular state does not have the film forming capability, so that it is dissolved in a binder that has a film forming capabilities and the resultant solution is coated on the charge generation layer and dried to form the charge transport layer. The thickness of the charge transport layer may vary according to the application, and can be in the range of about 5-50 μm.

In the single-layer photoreceptor, the charge generation and transport layer can be formed by dispersing the phthalocyanine-based pigment and a known binder with a solvent, coating the dispersed product on the conductive substrate, and then drying the coated product. In the preparation process, there is no need to additionally use a charge transporting material because the phthalocyanine pigment itself is a photoconductive material and has a charge transporting capability. In the charge generation and transport layer, the amount of the phthalocyanine-based pigment may be in the range of about 1-40 wt %. However, a known charge transporting material can be used together in order to increase plasticity of a film and a charge transporting efficiency. When the charge transporting material is additionally used, the amount of phthalocyanine-based pigment contained in the charge generation and transport layer may be in the range of about 0.1-50 wt %, and preferably about 0.2-10 wt %, and the amount of the resin may be in the range of 20-70 wt %.

The charge transporting material can be a hole transporting material, an electron transporting material, or a mixture of these, and preferably the mixture of the hole transporting material and the electron transporting material. In the mixture of the hole transporting material and the electron transporting material, the ratio of the hole transporting material and the electron transporting material may vary according to polarity or mobility of charges. The thickness of the charge generation and transportation layer may be in the range of about 5-50 μm.

As the transporting material used in the embodiment of the present invention, the hole transporting material can be a known hole transporting material, such as hydrazone-based compound, pyrazoline-based compound, oxadiazole compound, styryl compound, arylamine compound, oxazole-based compound, pyrazoline-based compound, pyrazolone-based compound, stylbene compound, polyaryl alkane-based compound, polyvinylcarbazole-based compound and a derivative thereof, N-acrylamidmethylcarbazole polymer, quinoxaline polymer, vinyl polymer, triphenylmethane polymer, stylene copolymer, polyacenaphthen, polyindene, a copolymer of acenaphthylene and stylene, or formaldehyde-based condensed resin..

The electron transporting material can be a known electron transporting material, such as benzoquinone-based compound, naphthoquinone-based compound, anthraquinone-based compound, malononitrile-based compound, fluorenone-based compound, dicyanofluorenone-based compound, benzoquinoneimine-based compound, diphenoquinone-based compound, stylben quinone-based compound, diiminonquinone-based compound, dioxotetracendion compound, or a sulfurized pyrane-based compound. Meanwhile, the charge transporting material used in the embodiment of the present invention is not limited to the hole transporting material or electron transporting material, and can be any transporting material having the mobility of 10⁻⁸ cm²/s or more. In some cases, at least two kinds of the charge transporting material can be used together.

In the electrophotographic photoreceptor according to an embodiment of the present invention, the charge generation layer, the charge transport layer, or the charge generation and transportation layer can be prepared using a second binder. The second binder can be a conductive resin having a film forming capability, such as polyvinylbutylral, polyacrylate (a condensed polymer of bisphenol A and phthalic acid, polycarbonate, polyester, phenoxy resin, polyacetic acid vinyl, acryl resin, polyacryl amide resin, polyamide, polyvinyl pyridine, cellulose-based resin, urethane resin, epoxy resin, silicon resin, polystyrene, polyketone, polyvinyl chloride, vinyl chloride-vinylic acid copolymer, polyvinylacetal, polyacrylonitrile, phenol resin, melamine resin, casein, polyvinyl alcohol, or polyvinyl pyrrolidone, or an organic photoconductive resin, such as poly N-vinylcarbazole, polyvinyl anthracene, or polyvinylpyrene.

The second binder used to prepare the charge transport layer may include the compound of Formula 3, such as PANLIGHT TS2050, PANLIGHT TS2040, or PANLIGHT TS2030, and/or the compound of Formula 4, such as TOUGHZET B-200, TOUGHZET B-300, or TOUGHZET B-500.

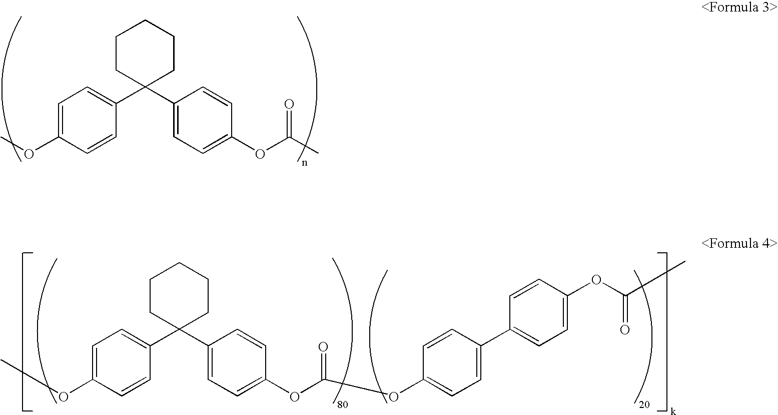

The second binder can be a polycarbonate binder resin or a mixture of at least two kinds of polycarbonates having different molecular weights. In some cases, the second binder can be a mixture of the compound of Formula 3 (PCZ) and the compound of Formula 4 (BPPC).

In the process of preparing the charge generation layer, the charge transport layer or the charge generation and transportation layer of the electrophotographic photoreceptor according to an embodiment of the present invention, the solvent of the coating solution may vary according to the used resin. The selected solvent may not affect an adjacent layer during the coating. The solvent may be selected from aromatic hydrocarbons, such as benzene, xylene, ligroin, monochlorobenzene, or dichlorobenzene; ketones, such as acetone, methylethylketone, or cyclohexanone; alcohols, such as methanol, ethanol, or isopropanol; esters, such as acetic acid ethyl, or methyl cellosolve; aliphatic halogenized hydrocarbons, such as carbon tetrachloride, chloroform, dichloromethane, dichloroethane, or trichloroethylene; ethers, such as tetrahydrofurane, dioxane, dioxolane, or ethylene glycol monomethyl ether; amides, such as N,N-dimethyl formamid, or N,N-dimethyl acetamid; and sulfoxides, such as dimethylsulfoxide. In the process of preparing the charge generation layer or the charge generation and transportation layer used in the embodiment of the present invention, a known charge generating material or a salt/pigment used to control spectroscopic sensitiveness can be used together with the phthalocyanine-based pigment. The charge generating material or a salt/pigrnent used to control spectroscopic sensitiveness can be bisazo-based compound, triazo-based compound, anthraquinone-based compound, perylene-based compound, perynone-based compound, azulenium salt-based compound, scuarium salt-based compound, polycyclo quinone, pyrolopyrrol compound, or phthalocyanine, such as naphthalocyanine.

Furthermore, in the process of preparing a photoreceptor using the phthalocyanine-based pigment, an electron receiving material may be further added to improve sensitiveness, to decrease the remaining charge potential, or to decrease a fatigue occurring when repeatedly used. The electron receiving material can be a compound having high electron affinity, such as anhydrous succinic acid, anhydrous maleic acid, dibrom anhydrous succinic acid, anhydrous phthalic acid, 3-nitro anhydrous phthalic acid, 4-nitro anhydrous phthalic acid, anhydrous pyromellitic acid, pyromellitic acid, trimellitic acid, anhydrous trimellitic acid, phthalimid, 4-nitrophthalimid, tetracyanoethylene, tetracyanoquinodimethane, chloranyl, bromanyl, o-nitro benzoic acid, or p-nitro benzoic acid.

The amount of the electron receiving material may be in the range of about 0.01-100 wt % based on the total weight ofthe charge generating material. In addition, the photoreceptor may further include a deterioration preventing agent, such as an antioxidant or a light stabilizer, to improve the resistance to the environment and improve the stability with respect to harmful light. The deterioration preventing agent can be a chromanol derivative, such as tocopherol, an etherfied compound of the chromanol derivative, an esterified compound of the chromanol derivative, polyaryl alkane compound, hydroquinone derivative, mono and dietherified compounds of the hydroquinone derivative, benzophenone derivative, benzotriazole derivative, ether sulfide compound, phenylenediamine derivative, phosphonic acid ester, phosphorous acid ester, phenol compound, phenol compound having a steric hindrance, linear amine compound, ring amine compound, or an amine compound having a steric hindrance. The antioxidant may be the same as in the undercoat.

An electrophotographic imaging apparatus including the organophotoreceptor according to an embodiment of the present invention, an electrophotographic drum including the organophotoreceptor according to an embodiment of the present invention, an electrophotographic cartridge including the organophotoreceptor according to an embodiment of the present invention will now be described in detail. First, the electrophotographic imaging apparatus will be described.

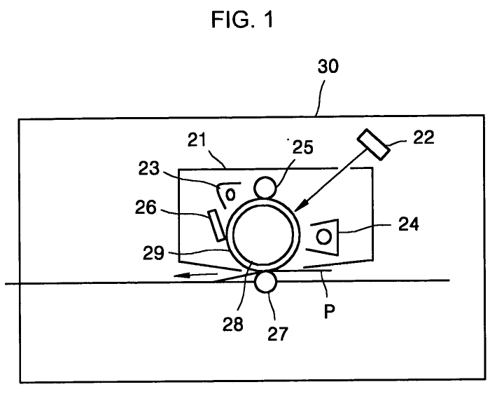

FIG. 1 is a schematic view of an electrophotographic imaging apparatus 30 including an electrophotographic drum 28 and an electrophotographic cartridge 21, according to an embodiment of the present invention. The electrophotographic cartridge 21 includes an organophotoreceptor 29, at least one charging device 25 that charges the organophotoreceptor 29, a developing device 24 that develops an electrostatic latent image formed on the organophotoreceptor 29, and a cleaning device 26 that cleans the surface of the organophotoreceptor 29. The electrophotographic cartridge 21 can be installed in the electrophotographic imaging apparatus 30 and separated from the electrophotographic imaging apparatus 30.

In the electrophotographic imaging apparatus 30, the organophotoreceptor 29 is located on the electrophotographic drum 28, and the organophotoreceptor 29 and the electrophotographic drum 28 can be installed in the electrophotographic imaging apparatus 30 and separated from the electrophotographic imaging apparatus 30.

In general, the electrophotographic imaging apparatus 30 includes a photoreceptor unit including the organophotoreceptor drum 28 and the electrophotographic drum 29; the charging device 25 that charges the photoreceptor unit; an imagewise light irradiation device 22 that irradiates an imagewise light to a photoreceptor unit charged by the charging device in order to form a electrostatic latent image on the photoreceptor unit; the developing unit 24 that develops the elastic latent image using a toner in order to form a toner image on the photoreceptor unit; and a transferring device 27 that transfers the toner image onto a receptor, such as paper P. The photoreceptor unit includes the organophotoreceptor 29 which will be described in detail. The charging device 25 is included in a charging unit, and can be provided with voltage and charge the organophotoreceptor 29 by contacting the organophotoreceptor 29. The electrophotographic imaging apparatus 30 may further include a pre-exposure unit 23 that removes the latent charge at the surface of the organophotoreceptor 29 in order to prepare a next cycle.

The organophotoreceptor according to an embodiment of the present invention can be used in an electrophotographic imaging apparatus, such as a laser printer, a copier, or a facsimile.

The present invention will be described in further detail with reference to the following examples. These examples are for illustrative purposes only and are not intended to limit the scope of the present invention. In Preparation Examples and Examples, ‘parts’ and ‘%’ denote parts by weight and % by weight, respectively.

### PREPARATION EXAMPLE 1

800 parts of methanol was added to 20 parts (0.112 mole) of 2,3-naphthalene dicarbonitrile and then 36.38 parts (0.168 mole) of sodium methoxide was added thereto in a nitrogen atmosphere in a flask installed with a refluxing device. The resultant solution was reacted at a temperature of 60-80° C. for 1-3 hours. The reaction product was cooled to 0° C.□ or lower so that a yellow product was formed. The yellow product was filtered, washed using a cooled methanol, and then dried at 40° C. for 10 hours in a vacuum oven. As a result, an imine derivative of the 2,3-naphthalene dicarbonitrile was obtained. 27.3 parts (0.213 mole) of phthalonitrile and 16.48 parts (0.071 mole) of the imine derivative of the 2,3-naphthalene dicarbonitrile prepared as described above were added to 450 parts of α-chloronaphthalene and then 14.84 parts (0.078 mole) of titan tetrachloride was dropwise added thereto in a nitrogen atmosphere in a flask installed with a refluxing device. Then, the resultant mixture was reacted at 200-220° C. for 4 hours while being mixed. Then, the reaction product was filtered at 100-130° C., and the filtered pigment was sequentially washed using α-chloronaphthalene, methanol, and water. The washed pigment was dispersed in 1000 parts of 5% ammonia water, and then heated and mixed at 90° C. for 2 hours. The resultant solution was filtered and dried at 40° C. in a vacuum oven for 10 hours. As a result, 16.95 parts of a mixture of oxotitanyl phthalocyanine and a derivative of the oxotitanyl phthalocyanine in which a benzene ring is substituted with a naphthalene ring.

The mixture of oxotitanyl phthalocyanine and the oxotitanyl phthalocyanine derivative was analyzed using a mass spectrometer. As a result, it was found from the intensity ratio that an oxotitanyl phthalocyanine derivative in which one of the benzene rings of the oxotitanyl phthalocyanine is substituted with 2,3-naphthalene was 40%.

### PREPARATION EXAMPLE 2

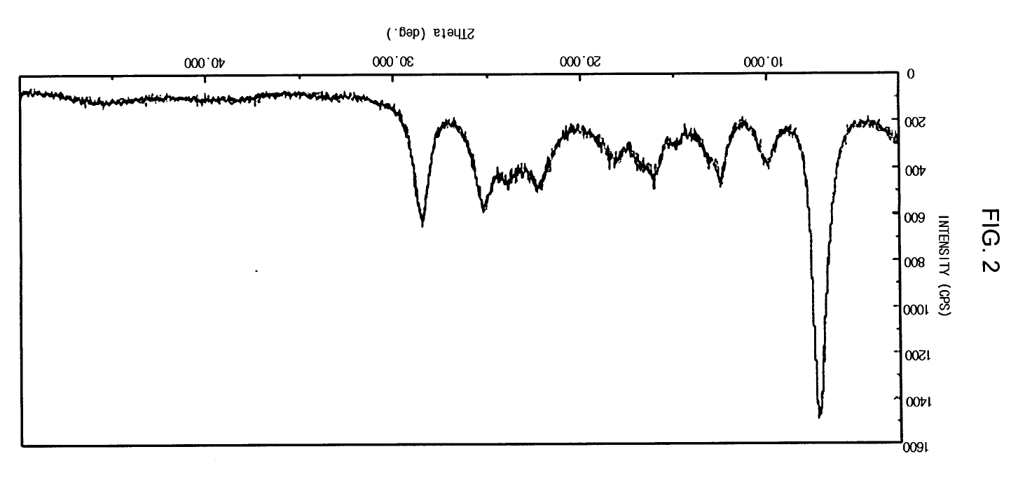

10 parts of the mixture obtained according to Preparation Example 1 was mixed and dissolved in 200 parts of 98% sulfuric acid at a temperature of 0□ or lower. The resultant sulfuric acid solution was added to 2000 parts of water at 0□ or lower while being stirred to reprecipitate a cocrystal of the oxotitanyl phthalocyanine and the oxotitanyl phthalocyanine derivative. The precipitated cocrystal was filtered and washed until the filtering solution became neutral. 200 parts of dichlorobenzene was added to the wet cocrystal of the oxotitanyl phthalocyanine and the oxotitanyl phthalocyanine derivative and then treated using zirconium oxide balls having a diameter of 5 mm and a ball mill for 78 hours. The dispersed solution was added to a great amount of acetone so that the cocrystal aggregated. The aggregated cocrystal was filtered, washed, and then dried in a vacuum oven at 40□. An X-ray diffraction (XRD) of the obtained product was measured. The results are shown in FIG. 2.

5 parts of the dried cocrystal, 2.5 parts of polyvinylbutyral resin (BM2: Sekisui Kagaku Kogyo), and 80 parts of tetrahydrofurane were dispersed using an alkali glass bead having a diameter of 1-1.5 mm and a paint shaker for 30 minutes. Such dispersion process was repeated four times. Then, 272 parts of tetrahydrofurane was added to the dispersed product to prepare a coating solution for a charge generation layer.

### PREPARATION EXAMPLE 3

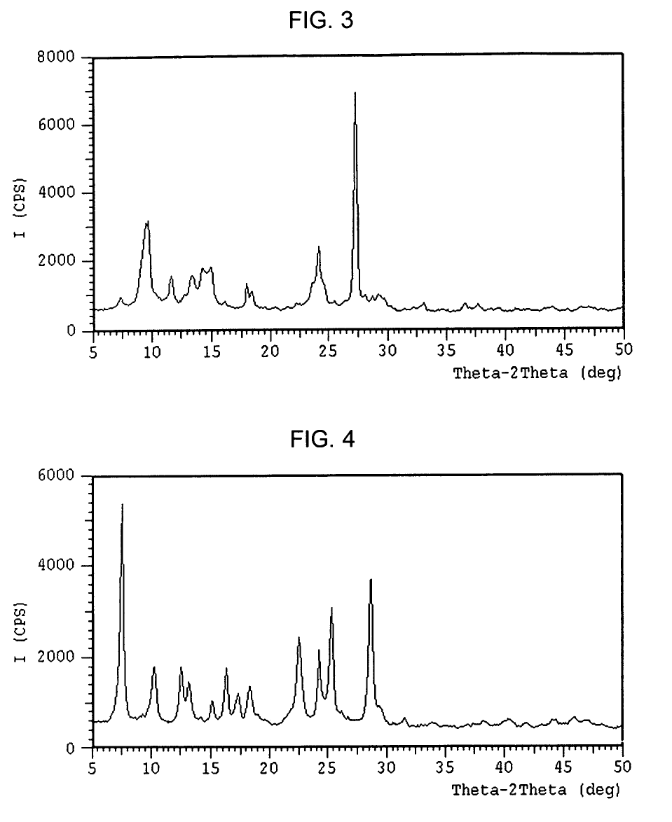

A coating solution for a charge generation layer was prepared in the same manner as in Preparation Example 2, except that 9.5 parts of oxotitanyl phthalocyanine and 0.5 parts of the mixture of the oxotitanyl phthalocyanine and the oxotitanyl phthalocyanine derivative prepared according to Preparation Example 1 were used instead of 10 parts of the mixture of the oxotitanyl phthalocyanine and the oxotitanyl phthalocyanine derivative. The XRD of the mixture of the oxotitanyl phthalocyanine and the phthalocyanine derivative was measured. The results are shown in FIG. 3.

### PREPARATION EXAMPLE 4

9.5 parts of oxotitanyl phthalocyanine and 0.5 parts of the mixture of the oxotitanyl phthalocyanine and the oxotitanyl phthalocyanine derivative prepared according to Preparation Example 1 were used instead of 10 parts of the mixture of the oxotitanyl phthalocyanine and the oxotitanyl phthalocyanine derivative used in Preparation Example 2, and a crystal form was obtained using the method according to Comparative Preparation Example 2. The XRD of the dried cocrystal was measured. The results are shown in FIG. 4. 5 parts of the dried cocrystal, 2.5 parts of polyvinylbutylal resin (BM2: Sekisui Kagaku Kogyo), and 80 parts of tetrahydrofurane were dispersed using an alkali glass bead having a diameter of 1-1.5 mm and a paint shaker for 30 minutes. Such dispersion process was repeated four times. Then, 272 parts of tetrahydrofurane was added to the dispersed product to prepare a coating solution for a charge generation layer.

### COMPARATIVE PREPARATION EXAMPLE 1

An oxotitanyl phthalocyanine was prepared in the same manner as in Preparation Example 1, except that 0.071 mole of phthalonitrile was used instead of 0.071 mole of the imine derivative of 2,3-naphthalenedicarbonitril. Then, the same experiment as Preparation Example 2 was carried out to prepare a coating solution for a charge generation layer.

### COMPARATIVE PREPARATION EXAMPLE 2

Alpha-type titanyl phthalocyanine was prepared according to the method disclosed in U.S. Pat. No. 4,728,592. 5 parts of alpha-type titanyl phthalocyanine, 2.5 parts of polyvinylbutylal resin (BM2: Sekisui Kagaku Kogyo), and 80 parts of tetrahydrofurane were dispersed using an alkali glass bead having a diameter of 1-1.5 mm and a paint shaker for 30 minutes. Such dispersion process was repeated four times. Then, 272 parts of tetrahydrofurane was added to the dispersed product to prepare a coating solution for a charge generation layer.

### EXAMPLE 1

80 parts by weight of nylon resin (CM8000 produced by Toray Co.) was dissolved in 320 parts by weight of an organic solvent (methanol/propanol=1/1 wt %) and then 4000 parts by weight of 5 mmΦ alumina ball, 160 parts by weight of titan oxide (TTO-55N produced by Ishihara Co.), and 4 parts by weight of antioxidant 2,6-di-tert-butyl-4-methylphenol were added thereto and dispersed using a ball mill for 20 hours. The dispersion solution was diluted using 1120 parts by weight of an organic solvent to prepare a coating solution for an undercoat.

The coating solution for an undercoat was coated on an aluminum drum to a thickness of 1-5 μm and dried at 60° C. in an oven for 30 minutes to form an undercoat. The coating solution for a charge generation layer prepared according to Preparation Example 3 was coated on the undercoat to a thickness of 0.2 μm and dried to form a charge generation layer. Then, a coating solution for a charge transport layer prepared by dissolving 4.2 parts of 4-dibenzylamino-2-methyl benzaldehyde diphenyl hydrazone(CTC191 produced by Takasago Co.), 4.2 parts of 1,1-bis-(para-diethyl aminophenyl)-4,4-diphenyl-1,3-butadiene(T405 produced by Takasago Co.), 10.5 parts of polycarbonate resin (B500 produced by Idemitz), 1 part of an antioxidant (IrganoX 565 produced by Ciba-Geigy Co.), and 1 part of antioxidant tris(2-t-butyl-4-methylphenyl)phosphite in 70 parts of tetrahydrofurane and 8.6 parts of xylene was coated on the dried charge transport layer to form a charge transport layer having a thickness of 20 μm and then dried. As a result, a negative charge multi-layer photoreceptor was manufactured. The electrostatic properties of the organophotoreceptor were measured using an electrostatic property measuring device (QEA-2000) and an optical fatigue thereof was measured.

### EXAMPLE 2

This experiment was carried out in the same manner as in Example 1, except that the coating solution for the charge transport layer was prepared using 8.4 parts by weight of N,N′-bis(3-methylphenyl)-N,N′-bis(phenyl)benzidine instead of 4.2 parts of 4-dibenzylamino-2-methylbenzaldehydediphenylhydrazone (CTC191 produced by Takasago Co.) and 4.2 parts of 1,1-bis-(para-diethylaminophenyl)-4,4-diphenyl-1,3-butadiene (T405 produced by Takasago Co.).

### EXAMPLE 3

This experiment was carried out in the same manner as in Example 1, except that the coating solution for the charge transport layer was prepared using 4.2 parts by weight of N,N′-bis(3-methylphenyl)-N,N′-bis(phenyl)benzidine and 4.2 parts by weight of N,N,N′,N′-tetrakis(4-methylphenyl)benzidine instead of 4.2 parts of 4-dibenzylamino-2-methylbenzaldehydediphenylhydrazone(CTC191 produced by Takasago Co.) and 4.2 parts of 1,1-bis-(para-diethylaminophenyl)-4,4-diphenyl-1,3-butadiene (T405 produced by Takasago Co.).

### EXAMPLE 4

This experiment was carried out in the same manner as in Example 1, except that the coating solution for the charge transport layer was prepared using 4.2 parts by weight of N,N′-bis(3-methylphenyl)-N,N′-bis(phenyl)benzidine and 4.2 parts by weight of 4-methoxyphenyldiphenylamine instead of 4.2 parts of 4-dibenzylamino-2-methylbenzaldehydediphenylhydrazone(CTC191 produced by Takasago Co.) and 4.2 parts of 1,1-bis-(para-diethylaminophenyl)-4,4-diphenyl-1,3-butadiene (T405 produced by Takasago Co.).

### COMPARATIVE EXAMPLE 1

This experiment was carried out in the same manner as in Example 1, except that the coating solution for a charge generation layer prepared according to Preparation Example 1 was used.

### COMPARATIVE EXAMPLE 2

This experiment was carried out in the same manner as in Example 1, except that an aluminum drum that was treated with alumite was used instead of the undercoat.

### EXAMPLE 5

This experiment was carried out in the same manner as in Example 1, except that the coating solution for a charge generation layer prepared according to Preparation Example 4 was used.

### EXAMPLE 6

This experiment was carried out in the same manner as in Example 1, except that the coating solution for a charge generation layer prepared according to Preparation Example 4 was used, and the coating solution for a charge transport layer was prepared using 8.4 parts by weight of N,N′-bis(3-methylphenyl)-N,N′-bis(phenyl)benzidine instead of 44.2 parts of 4-dibenzylamino-2-methylbenzaldehydediphenylhydrazone (CTC191 produced by Takasago Co.) and 4.2 parts of 1,1-bis-(para-diethylaminophenyl)-4,4-diphenyl-1,3-butadiene (T405 produced by Takasago Co.).

### EXAMPLE 7

This experiment was carried out in the same manner as in Example 1, except that the coating solution for a charge generation layer prepared according to Preparation Example 4 was used, and the coating solution for a charge transport layer was prepared using 4.2 parts by weight of N,N′-bis(3-methylphenyl)-N,N′-bis(phenyl)benzidine, and 4.2 parts by weight of N,N,N′,N′-tetrakis(4-methylphenyl)benzidine instead of 44.2 parts of 4-dibenzylamino-2-methylbenzaldehydediphenylhydrazone (CTC191 produced by Takasago Co.) and 4.2 parts of 1,1-bis-(para-diethylaminophenyl)-4,4-diphenyl-1,3-butadiene (T405 produced by Takasago Co.).

### EXAMPLE 8

This experiment was carried out in the same manner as in Example 1, except that the coating solution for a charge generation layer prepared according to Preparation Example 4 was used, and the coating solution for a charge transport layer was prepared using 4.2 parts by weight of N,N′-bis(3-methylphenyl)-N,N′-bis(phenyl)benzidine and 4.2 parts by weight of 4-methoxyphenyldiphenylamine instead of 44.2 parts of 4-dibenzylamino-2-methylbenzaldehydediphenylhydrazone (CTC191 produced by Takasago Co.) and 4.2 parts of 1,1-bis-(para-diethylaminophenyl)-4,4-diphenyl-1,3-butadiene (T405 produced by Takasago Co.).

### COMPARATIVE EXAMPLE 3

This experiment was carried out in the same manner as in Example 1, except that the coating solution for a charge generation layer prepared according to Preparation Example 2 was used.

### COMPARATIVE EXAMPLE 4

This experiment was carried out in the same manner as in Example 1, except that an aluminum drum that was treated with alumite was used instead of the undercoat, and the coating solution for a charge generation layer prepared according to Preparation Example 2 was used.

Properties of the photoreceptors prepared according to Examples 1-8 and Comparative Examples 1-4 were measured. The results are shown in Table 1. Methods of measuring properties of photoreceptors and definition of marks are described.

TABLE 1

| | Section | | | | | |
|---|---|---|---|---|---|---|
| | Initial | | | After 2000 cycles | | |
| Properties | E_{1/2} | E₁₀₀ | Vᵣ | E_{1/2} | E₁₀₀ | Vᵣ |
| Example 1 | 0.16 | 0.45 | 8.5 | 0.15 | 0.42 | 25.4 |
| Example 2 | 0.15 | 0.52 | 11.4 | 0.13 | 0.48 | 38.2 |
| Example 3 | 0.14 | 0.42 | 10.2 | 0.13 | 0.32 | 30.7 |
| Example 4 | 0.14 | 0.40 | 9.8 | 0.14 | 0.35 | 32.5 |
| Example 5 | 0.37 | 0.83 | 6.6 | 0.35 | 0.79 | 28.4 |
| Example 6 | 0.35 | 0.82 | 7.0 | 0.32 | 0.75 | 34.5 |
| Example 7 | 0.33 | 0.78 | 10.0 | 0.32 | 0.74 | 32.2 |
| Example 8 | 0.34 | 0.80 | 9.5 | 0.33 | 0.78 | 31.0 |
| Comparative | 0.16 | 0.46 | 8.0 | 0.13 | 0.32 | 45.3 |
| Example 1 | | | | | | |
| Comparative | 0.15 | 0.42 | 8.2 | 0.14 | 0.40 | 34.2 |
| Example 2 | | | | | | |
| Comparative | 0.36 | 0.82 | 7.0 | 0.34 | 0.75 | 40.3 |
| Example 3 | | | | | | |
| Comparative | 0.35 | 0.80 | 6.2 | 0.35 | 0.78 | 36.4 |
| Example 4 | | | | | | |

Note)
E_{1/2}(μJ/cm²): Exposure energy required until the initial charge potential (V₀) drops to V₀/2;
E₁₀₀(μJ/cm²): Exposure energy required until the initial charge potential (V₀) drops to −100 V; and
Vᵣ(−V): Latent potential after 10-second light irradiation after charged

As a result of measuring a photo fatigue, it was found that E_{1/2} and E₁₀₀ sensitiveness were stable and the increase of the latent potential was suppressed.

As described above, an organophotoreceptor according to the present invention provides a stable image quality obtained by uniform coating with a coating solution for a charge generation layer having high dispersion stability and high storage stability and excellent electrical properties. Accordingly, the organophotoreceptor is very useful for preparation of an electrophotographic photoreceptor having excellent electrical properties and image properties. An electrophotographic photoreceptor according to the present invention has high sensitiveness to a long wavelength of about 780 nm so that the electrophotographic photoreceptor can be used in a laser printer, a copier, a facsimile, or a multifunction apparatus, all of which uses light of such a long wavelength.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An organophotoreceptor comprising:
a conductive support;
an undercoat comprising a metal oxide and a first antioxidant dispersed in a first binder;
a charge generation layer comprising a phthalocyanine-based pigment; and
a charge transport layer.

2. The organophotoreceptor of claim 1, wherein the first antioxidant comprises a phenol-based antioxidant, a phosphite-based antioxidant, or mixtures thereof.

3. The organophotoreceptor of claim 2, wherein the phenol-based antioxidant comprises at least one phenol selected from the group consisting of 2,6-di-tert-butylphenol, 2,6-di-tert-butyl-4-methoxyphenol, 2,6-di-tert-butyl-4-methylphenol, 2-tert-butyl-4-methoxyphenol, 2,4-dimethyl-6-tert-butylphenol, 2-tert-butylphenol, 3,6-di-tert-butylphenol, 2,4-di-tert-butylphenol, 2,6-di-tert-butyl-4-ethylphenol, 2-tert-butyl-4,6-methylphenol, 2,4,6-tert-butylphenol, 2,6-di-tert-butyl-4-stearylpronate phenol, α-tocopherol, β-tocopherol, γ-tocopherol, naphthol AS, naphthol AS-D, naphthol AS-BO, 4,4′-methylenebis(2,6-di-tert-butylphenol), 4,4′-methylenebis(6-tert-butyl-4-methylphenol), 2,2′-methylenebis(4-methyl-6-tert-butylphenol), 2,2′-methylenebis(4-ethyl-6-tert-butylphenol), 2,2′-ethylenebis(4,6-di-tert-butylphenol), 2,2′-propylenebis(4,6-di-tert-butylphenol), 2,2′-butanebis(4,6-di-tert-butylphenol), 2,2′-ethylenebis(6-tert-butyl-m-crezole), 4,4′-butanebis(6-tert-butyl-m-crezole), 2,2′-butanebis((6-tert-butyl-p-crezole), 2,2′-thiobis((6-tert-butylphenol), 4,4′-thiobis(6-tert-butyl-m-crezole), 4,4′-thiobis(6-tert-o-crezole), 2,2′-thiobis(4-methyl-6-tert-butylphenol), 1,3,5-trimethyl-2,4,6-tris(3,5-di-tert-butyl-4-hydroxybenzyl)benzene, 1,3,5-trimethyl-2,4,6-tris(3,5-di-tert-amyl-4-hydroxybenzyl)benzene, 1,3,5-trimethyl-2,4,6-tris(3-tert-butyl-5-methyl-4-hydroxybenzyl)benzene, 2-tert-butyl-5-methyl-phenylaminephenol, 4,4′bisamino(2-tert-butyl-4-methylphenol), N-octadecyl-3-(3′,5′-di-tert-butyl-4′-hydroxyphenyl)propionate, 2,2,4-trimethyl-6-hydroxy-7-tert-butylchroman, tetrakis(methylene-3(3,5-di-tert-butyl-4-hydroxyphenyl)propionate)methane, and 1,1,3-tris(2-methyl-4-hydroxy-5-tert-butylphenyl)butane.

4. The organophotoreceptor of claim 2, wherein the phosphite-based antioxidant comprises at least one phosphite selected from the group consisting of tri(2,4-di-t-butylphenyl)phosphite, bis(2,4-di-t-butylphenyl)pentaerythritol diphosphite, bis(2,4-di-dicumylphenyl)pentaerythritol diphosphite, tri(4-n-nonylphenyl)phosphite, and tetrakis(2,4-di-tert-butyl-phenyl) 4,4′-biphenylene-diphosphite.

5. The organophotoreceptor of claim 1, wherein the amount of the first antioxidant is in the range of about 0.01-20 parts based on 100 parts by weight of the first binder.

6. The organophotoreceptor of claim 1, wherein the phthalocyanine-based pigment is a phthalocyanine-based derivative of Formula 1, a phthalocyanine-based compound of Formula 2, or a mixture or cocrystal thereof: 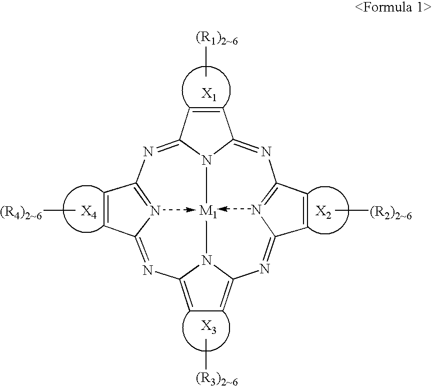
where X₁, X₂, X₃, and X₄ are each independently a substituted or unsubstituted 2,3-naphthalene ring or a substituted or unsubstituted benzene ring, and at least one of X₁, X₂, X₃, and X₄ is a 2,3-naphthalene ring;
R₁, R₂, R₃, and R₄ are each independently a hydrogen atom, a halogen atom, a nitro group, a substituted or unsubstituted C1-20 alkyl group, or a substituted or unsubstituted C1-20 alkoxy group; and
M₁ is a hydrogen molecule, a halogenated aluminum, or Ti, V, Zr, Ge, Ga, Sn, Si, or In having an oxygen atom, a halogen atom, or hydroxyl group bound thereto; and 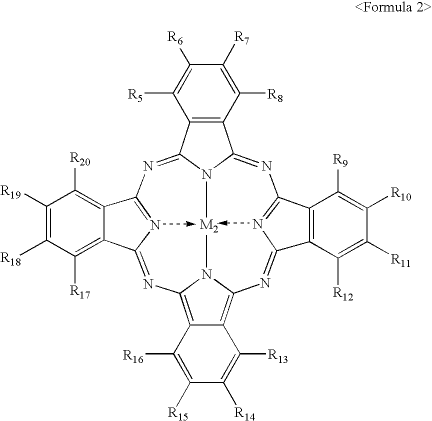
where M₂ is a hydrogen molecule, Cu, Fe, Mg, Sn, Pb, Zn, Co, Ni, Mo, halogenated aluminum, or Ti, V, Zr, Ge, Ga, Sn, Si, or In to which an oxygen atom, a halogen atom, or a hydroxyl group is bound; and
R₅, R₆, R₇, R₈, R₉, R₁₀, R₁₁, R₁₂, R₁₃, R₁₄, R₁₅, R₁₆, R₁₇, R₁₈, R₁₉, and R₂₀ are each independently a hydrogen atom, a halogen atom, a nitro group, a substituted or unsubstituted C₁₋₂₀ alkyl group, or a substituted or unsubstituted C₁₋₂₀ alkoxy group.

7. The organophotoreceptor of claim 6, wherein, in the mixture or cocrystal of the phthalocyanine-based derivative of Formula 1 and the phthalocyanine-based compound of Formula 2, the weight ratio of the phthalocyanine-based derivative of Formula 1 to the phthalocyanine-based compound of Formula 2 is in the range of about 0.0001:1-0.5:1.

8. The organophotoreceptor of claim 6, wherein the phthalocyanine-based pigment is the cocrystal of the phthalocyanine-based derivative of Formula 1 and the phthalocyanine-based compound of Formula 2.

9. The organophotoreceptor of claim 8, wherein the cocrystal of the phthalocyanine-based derivative of Formula 1 and the phthalocyanine-based compound of Formula 2 has a crystal form of a γ-type or Y-type oxotitanyl phthalocyanine of which the sharpest diffraction peak appears at a Bragg angle (2θ±0.2°) of 27.1° in an X-ray diffraction spectrum.

10. The organophotoreceptor of claim 8, wherein the cocrystal of the phthalocyanine-based derivative of Formula 1 and the phthalocyanine-based compound of Formula 2 has a crystal form of an α-type oxotitanyl phthalocyanine crystal of which the sharpest diffraction peak appears at a Bragg angle (2θ±0.2°) of 7.5° in an X-ray diffraction spectrum.

11. The organophotoreceptor of claim 8, wherein the cocrystal of the phthalocyanine-based derivative of Formula 1 and the phthalocyanine-based compound of Formula 2 has a crystal form of an X-type nonmetallic phthalocyanine crystal of which sharp diffraction peaks appear at Bragg angles (2θ±0.2°) of 7.5° and 9.2° in an X-ray diffraction spectrum.

12. The organophotoreceptor of claim 1, wherein the amount of the phthalocyanine-based pigment is in the range of about 10-100 wt % based on the total weight of the charge generation layer.

13. The organophotoreceptor of claim 1, wherein the thickness of the charge generation layer is in the range of about 0.001-10 μm.

14. The organophotoreceptor of claim 1, wherein the metal oxide comprises at least one oxide selected from the group consisting of tin oxide, indium oxide, zinc oxide, titan oxide, silicon oxide, zirconium oxide, and aluminum oxide.

15. The organophotoreceptor of claim 1, wherein the binder comprises at least one resin selected from the group consisting of a thermosetting resin, an amino resin, a photosetting resin, a polyamid resin, a polyurethane resin, and an epoxy resin.

16. The organophotoreceptor of claim 1, wherein the weight ratio of the metal oxide and the binder is in the range of about 0.1/1-10/1.

17. The organophotoreceptor of claim 1, wherein the thickness of the undercoat is in the range of about 0.1-20 μm.

18. The organophotoreceptor of claim 1, wherein the charge transport layer comprises a charge transporting material and a second binder, wherein
the second binder is a Z-type polycarbonate represented by Formula 3, a BPPC represented by Formula 4, or a mixture thereof:

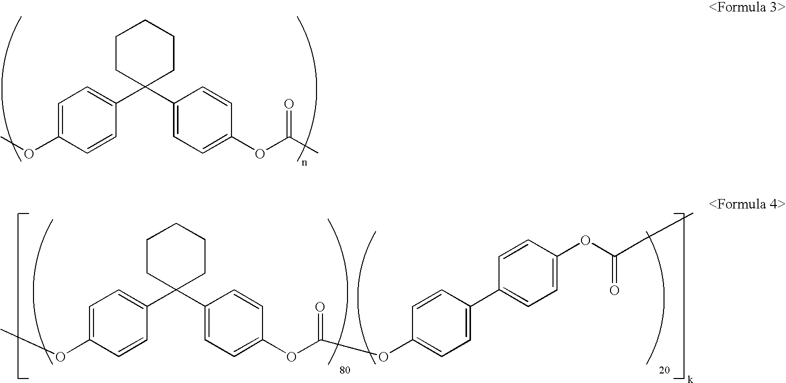

19. The organophotoreceptor of claim 18, wherein the charge transport layer further comprises a second antioxidant, wherein
the second antioxidant is a phenol-based antioxidant, a phosphite-based antioxidant, or a mixture thereof.

20. An electrophotographic imaging apparatus comprising the organophotoreceptor of claim 1.

21. An electrophotographic cartridge that is installed in an electrophotographic imaging apparatus and is separated from the electrophotographic imaging apparatus, the electrophotographic cartridge comprising:
the organophotoreceptor of claim 1; and
at least one device selected from the group consisting of a charging device that charges the organophotoreceptor, a developing device that develops a electrostatic latent image formed on the organophotoreceptor, and a cleaning device that cleans the surface of the organophotoreceptor.

22. An electrophotographic drum comprising:
a drum that is installed in an electrophotographic imaging apparatus and is separated from the electrophotographic imaging apparatus imaging apparatus; and
the organophotoreceptor of claim 1.

23. An electrophotographic imaging apparatus comprising:
a photoreceptor unit comprising the organophotoreceptor of claim 1;
a charging device that charges the photoreceptor unit;
an imagewise light irradiation device that irradiates an imagewise light to the photoreceptor unit in order to form a electrostatic latent image on the photoreceptor unit;
a developing unit that develops the electrostatic latent image using a toner in order to form a toner image on the photoreceptor unit; and
a transferring device that transfers the toner image onto a receptor.

24. An organophotoreceptor comprising:
a conductive support;
an undercoat comprising a metal oxide and a first antioxidant dispersed in a first binder;
a charge generation layer comprising a phthalocyanine-based pigment, wherein the phthalocyanine-based pigment is a cocrystal has a crystal form selected from the group consisting of γ-type or Y-type oxotitanyl phthalocyanine of which the sharpest diffraction peak appears at a Bragg angle (2θ±0.2°) of 27.1θ in an X-ray diffraction spectrum, an α-type oxotitanyl phthalocyanine crystal of which the sharpest diffraction peak appears at a Bragg angle (2θ±0.2°) of 7.5° in an X-ray diffraction spectrum, and X-type nonmetallic phthalocyanine crystal of which sharp diffraction peaks appear at Bragg angles (2θ±0.2°) of 7.5° and 9.2° in an X-ray diffraction spectrum; and
a charge transport layer.

25. The organophotoreceptor of claim 24, wherein the phthalocyanine-based pigment is a phthalocyanine-based derivative of Formula 1, a phthalocyanine-based compound of Formula 2, or a mixture or cocrystal thereof: 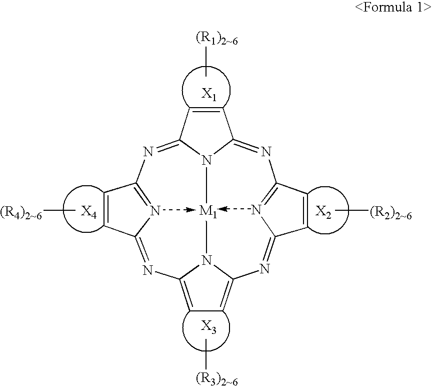
where X₁, X₂, X₃, and X₄ are each independently a substituted or unsubstituted 2,3-naphthalene ring or a substituted or unsubstituted benzene ring, and at least one of X₁, X₂, X₃, and X₄ is a 2,3-naphthalene ring;
R₁, R₂, R₃, and R₄ are each independently a hydrogen atom, a halogen atom, a nitro group, a substituted or unsubstituted C1-20 alkyl group, or a substituted or unsubstituted C1-C20 alkoxy group; and
M₁ is a hydrogen molecule, a halogenated aluminum, or Ti, V, Zr, Ge, Ga, Sn, Si, or In having an oxygen atom, a halogen atom, or hydroxyl group bound thereto; and 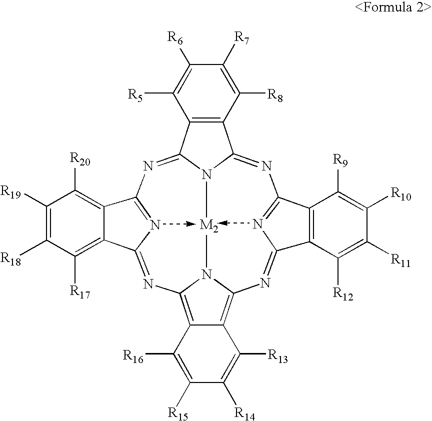
where M₂ is a hydrogen molecule, Cu, Fe, Mg, Sn, Pb, Zn, Co, Ni, Mo, halogenated aluminium, or Ti, V, Zr, Ge, Ga, Sn, Si, or In to which an oxygen atom, a halogen atom, or a hydroxyl group is bound; and
R₅, R₆, R₇, R₈, R₉, R₁₀, R₁₁, R₁₂, R₁₃, R₁₄, R₁₅, R₁₆, R₁₇, R₁₈, R₁₉, and R₂₀ are each independently a hydrogen atom, a halogen atom, a nitro group, a substituted or unsubstituted C₁₋₂₀ alkyl group, or a substituted or unsubstituted C₁₋₂₀ alkoxy group.
